(19) United States
(12) Patent Application Publication
(10) Pub. No.: US 2025/0282315 A1
(43) Pub. Date: Sep. 11, 2025

(54) RETRACTABLE BUMPER ASSEMBLY WITH LOCK

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US)

(73) Assignee: Ford Global Technologies, LLC, Dearborn, MI (US)

(21) Appl. No.: 18/599,985

(22) Filed: Mar. 8, 2024

(51) Int. Cl. B60R 19/28

(52) U.S. Cl. CPC B60R 19/28

(57) ABSTRACT

A vehicle-bumper assembly includes a bumper and a rod fixed relative to the bumper and elongated along an axis. A bracket is spaced from the bumper along the axis of the rod. The rod is movably engaged with the bracket 16 between a design position and a retracted position. A spring 18 is between the bumper and the bracket. The spring resiliently forces the bumper away from the bracket along the axis of the rod toward the design position. A keeper is releasably engaged with the bracket. The keeper maintains the rod in the design position when the keeper is engaged with the bracket. A lock is movable from a locked position in which the lock couples the keeper and the bracket and an unlocked position in which the lock is decoupled with the keeper and/or the bracket.

### BACKGROUND

The Global Technology Regulation (GTR) and the New Car Assessment Program (NCAP) specify leg-injury criteria for pedestrian protection. The regulations are aimed at reducing the impact force to the legs of a pedestrian by a vehicle bumper during certain vehicle-pedestrian impacts.

Some vehicles, such as light duty trucks and sport utility vehicles (SUVs), for example, may have a bumper height that could lead to an uneven impact on the femur and/or tibia of the pedestrian by the vehicle bumper during certain vehicle-pedestrian impacts. For example, light duty trucks may have bumper heights to provide ground clearance to clear speed bumps, curbs, parking blocks, inclined driveway ramps, hills, rough roads, etc. Some vehicles with such bumper heights also have off-road capabilities that preclude having any components below the bumper. As such, a design for the vehicle front-end is investigated for pedestrian leg impact energy management while addressing ground clearance requirements.

### BRIEF DESCRIPTION OF THE DRAWINGS

FIG. 1 is a perspective view of a portion of a vehicle including a vehicle-bumper assembly.

FIG. 2 is a perspective view of the vehicle with the vehicle-bumper assembly removed.

FIG. 3 is a partially exploded view of the vehicle-bumper assembly.

FIG. 4 is a top view of the vehicle-bumper assembly and a portion of a vehicle frame.

FIG. 5A is a perspective view of a portion of the vehicle-bumper assembly with a lock in a locked position.

FIG. 5B is a perspective with the lock in an unlocked position and a rod of the vehicle-bumper in a design position.

FIG. 5C is a perspective view with the lock in the unlocked position and the rod in a retracted position.

FIG. 6 is a perspective view of another example of the vehicle-bumper assembly.

FIG. 7 is a block diagram of a system of the vehicle.

FIG. 8 is a flow chart of an example method.

### DETAILED DESCRIPTION

A vehicle-bumper assembly includes a bumper and a rod fixed relative to the bumper and elongated along an axis. A bracket is spaced from the bumper along the axis of the rod. The rod is movably engaged with the bracket between a design position and a retracted position. A spring is between the bumper and the bracket. The spring resiliently forces the bumper away from the bracket along the axis of the rod toward the design position. A keeper is releasably engaged with the bracket. The keeper maintains the rod in the design position when the keeper is engaged with the bracket. A lock is movable between a locked position in which the lock couples the keeper and the bracket and an unlocked position in which the lock is decoupled from the keeper and/or the bracket.

The vehicle-bumper assembly may include a releasable connection between the keeper and bracket. The releasable connection may be designed to release the keeper from the bracket in response to certain frontal-vehicle impacts.

The vehicle-bumper assembly may include a shear pin between the keeper and the bracket.

The rod may extend through the bracket and the bracket is between the keeper and the bumper. The keeper may be disposed on the axis of the rod. The lock may include an actuator and a latch movable by the actuator. The latch may be movable by the actuator between the locked position in which the keeper is between the latch and the bracket and the unlocked position in which the latch is disengaged with the keeper. The actuator may be on the keeper.

The spring may be on the rod.

A vehicle may include a vehicle frame, a bumper, and a rod fixed relative to the bumper and elongated along an axis. A bracket is fixed relative to the vehicle frame and spaced from the bumper along the axis of the rod. The rod is movably engaged with the bracket between a design position and a retracted position. A spring is between the bumper and the bracket. The spring resiliently forces the bumper away from the bracket along the axis of the rod toward the design position. A keeper is releasably engaged with the bracket. The keeper maintains the rod in the design position when the keeper is engaged with the bracket. A lock is movable between a locked position in which the lock couples the keeper and the bracket and an unlocked position in which the lock decouples the keeper and/or the bracket.

The vehicle-bumper assembly may include a releasable connection between the keeper and bracket. The releasable connection may be designed to release the keeper from the bracket in response to certain frontal-vehicle impacts.

The vehicle-bumper assembly may include a shear pin between the keeper and the bracket.

The rod may extend through the bracket and the keeper is on a vehicle-rearward side of the bracket. The keeper may be disposed on the axis of the rod vehicle-rearward of the rod. The lock may include an actuator and a latch movable by the actuator. The latch is movable by the actuator between the locked position vehicle-rearward of the keeper and the unlocked position in which the latch is offset cross-vehicle from the keeper. The actuator may be on the keeper.

The spring may be on the rod.

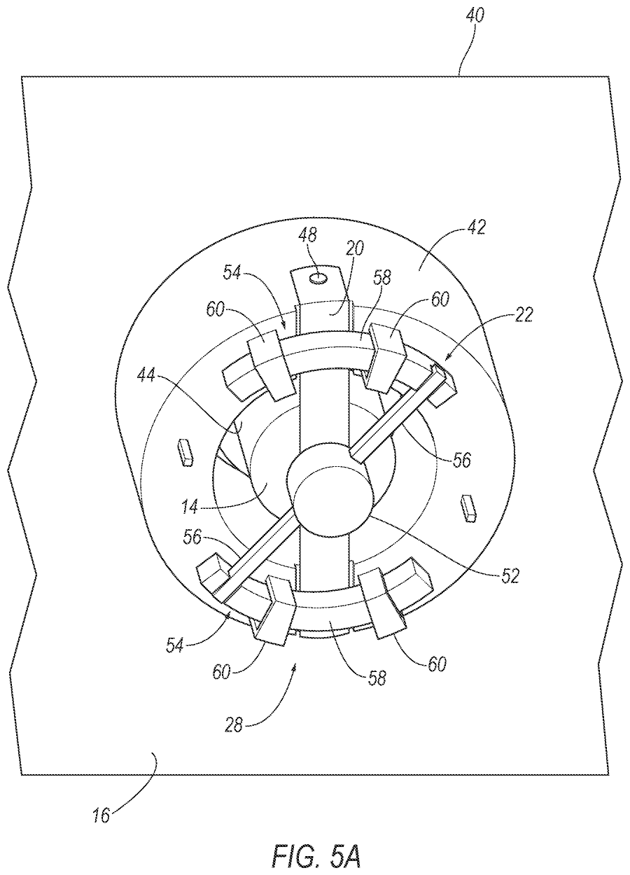

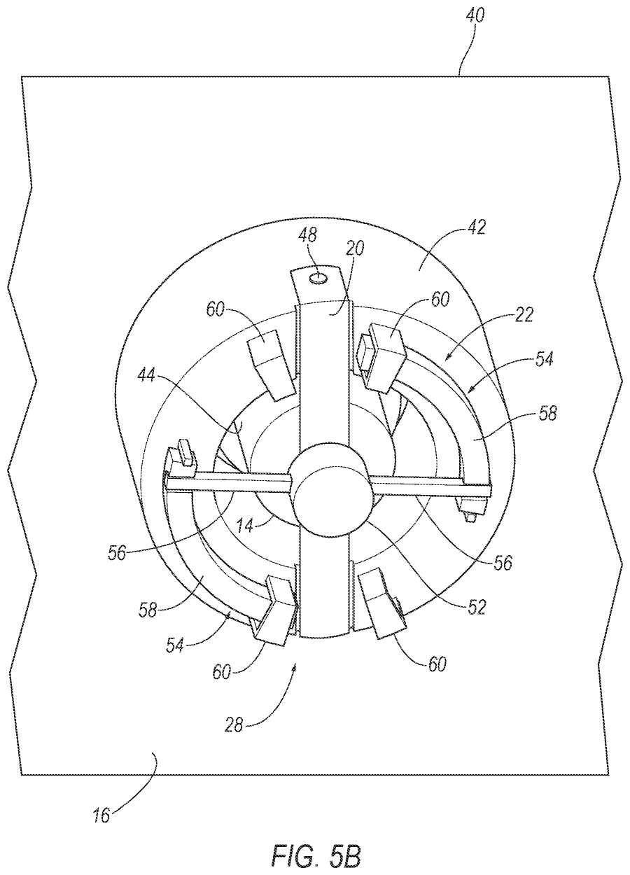

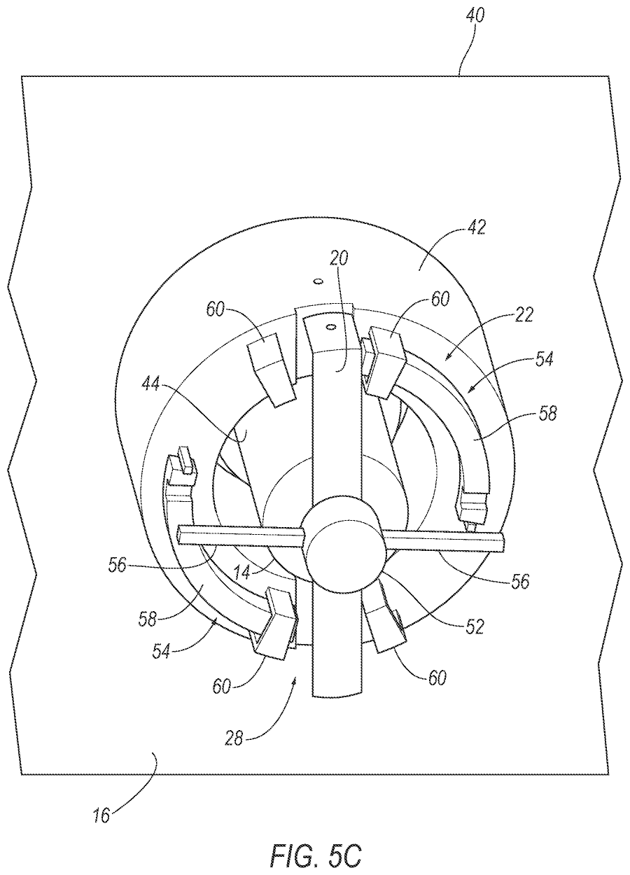

With reference to the Figures, wherein like numerals indicate like parts throughout the several views, a vehicle-bumper assembly 10 includes a bumper 12 and a rod 14 fixed relative to the bumper 12 and elongated along an axis A. A bracket 16 is spaced from the bumper 12 along the axis A of the rod 14. The rod 14 is movably engaged with the bracket 16 between a design position (FIGS. 5A-B) and a retracted position (FIG. 5C). A spring 18 is between the bumper 12 and the bracket 16. The spring 18 resiliently forces the bumper 12 away from the bracket 16 along the axis A of the rod 14 toward the design position. A keeper 20 is releasably engaged with the bracket 16. The keeper 20 maintains the rod 14 in the design position when the keeper 20 is engaged with the bracket 16. A lock 22 is movable from a locked position in which the lock 22 couples the keeper 20 and the bracket 16 and an unlocked position in which the lock 22 is decoupled with the keeper 20 and/or the bracket 16.

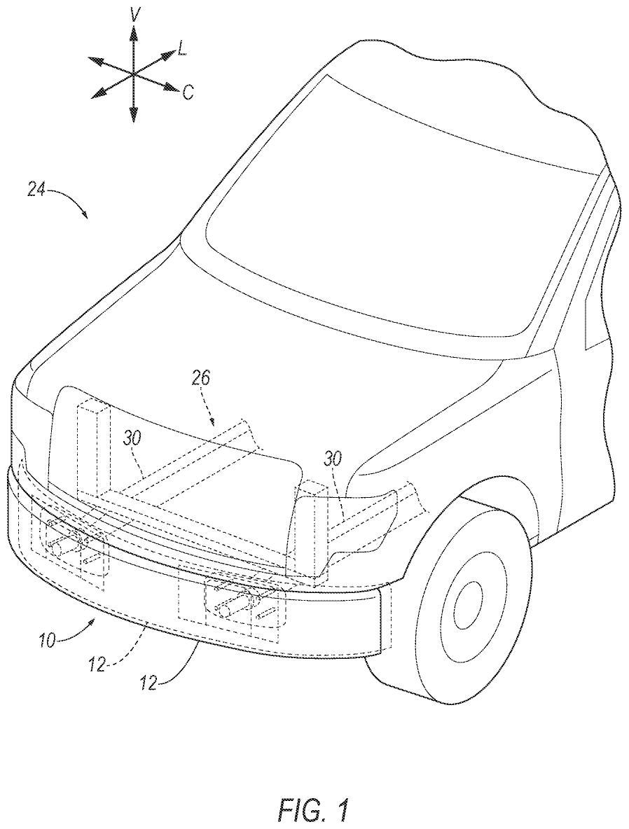

When the lock 22 is in the locked position, the lock 22 couples the keeper 20 to the bracket 16 to prevent axial movement of the rod 14 vehicle-rearward relative to the bracket 16. When the lock 22 is in the unlocked position, the lock 22 is decoupled from the keeper 20 and/or the bracket 16 so that the releasable engagement of the keeper 20 with the bracket 16 resists axial movement of the rod 14 vehicle-rearward relative to the bracket 16 unless axial force on the rod 14 reaches a level that releases the keeper 20 from the bracket 16. In a situation in which axial movement of the rod 14 releases the keeper 20 from the bracket 16, the bumper 12 and the rod 14 are movable as a unit from the design position toward the retracted position against the force of the spring 18. As described further below, the lock 22 may be selectively moved between the locked position and the unlocked position, for example, based on vehicle speed. In the event of certain vehicle impacts in which the bumper 12 impacts an object, e.g., a crash test leg form as described further below, the bumper 12 is retractable vehicle rearward from the design position (shown in solid lines in FIG. 1) to the retracted position (shown in broken lines in FIG. 1) against the force of the spring 18. For example, during impact with a leg form, the bumper 12 and rod 14 move vehicle rearward against the force of the spring 18 to absorb energy from the impact and reduce energy delivered from the bumper 12 to the leg form. In such examples, since the spring 18 biases the bumper 12 away from the bracket 16, when force is decreased or removed from the bumper 12, the spring 18 may move the bumper 12 toward the design position.

A vehicle 24 includes the vehicle-bumper assembly 10. The vehicle 24 includes a vehicle frame 26. The bracket 16 of the vehicle-bumper assembly 10 is fixed relative to the vehicle frame 26 and spaced from the bumper 12 along the axis A of the rod 14.

As described further below, the vehicle-bumper assembly 10 includes an energy-absorber assembly 28 between the vehicle frame 26 and the bumper 12. The energy-absorber assembly 28 includes the rod 14, the spring 18, and the bracket 16. The energy-absorber assembly 28 supports the bumper 12 on the vehicle frame 26 and selectively allows the bumper 12 to release from the design position to the retracted position in response to detection of certain vehicle impacts. As set forth below, the bumper assembly may include two energy-absorber assemblies that, in combination with each other, support the bumper 12 on the vehicle frame 26.

The bumper 12, as an example, may impact the knee of a pedestrian impact test leg form during a standardized test. The leg form may be a flexible pedestrian leg impactor (Flex-PLI) leg form. Example regulations that can use the leg form include Global Technical Regulation (GTR), ECE R127 and Korean Motor Vehicle 24 Safety Standards (KMVSS). Example new car assessment programs that can use the leg form include EuroNCAP, CNCAP, and ANCAP.

The vehicle 24 may be any suitable type of automobile, e.g., a passenger or commercial automobile such as a sedan, a coupe, a truck, a sport utility vehicle, a crossover vehicle, a van, a minivan, a taxi, a bus, etc. The vehicle 24, as an example, may have a relatively high ride height. With reference to FIG. 1, the vehicle 24 defines a vehicle-longitudinal axis L extending between a front end (not numbered) and a rear end (not numbered) of the vehicle 24. The vehicle 24 defines a vehicle-lateral axis C extending cross-vehicle from one side to the other side of the vehicle 24. The vehicle 24 defines a vertical axis V. The vehicle-longitudinal axis L, the vehicle-lateral axis C, and the vertical axis V are perpendicular relative to each other.

The vehicle 24 includes the vehicle frame 26 and a vehicle body. The vehicle body and the vehicle frame 26 may have a body-on-frame construction (also referred to as a cab-on-frame construction) in which the vehicle body and vehicle frame 26 are separate components, i.e., are modular, and the vehicle body is supported on and affixed to the vehicle frame 26. In the example shown in the Figures, the vehicle 24 has a body-on-frame construction. As another example, the vehicle body and the vehicle frame 26 may be of a unibody construction in which the vehicle frame 26 is unitary with the vehicle body (including frame rails 30, pillars, roof rails, etc.). Alternatively, the vehicle frame 26 and vehicle body may have any suitable construction. The vehicle frame 26 and vehicle body may be of any suitable material, for example, steel, aluminum, and/or fiber-reinforced plastic, etc.

The vehicle body includes body panels (not numbered). The body panels may include structural panels, e.g., rockers, pillars, roof rails, etc. The body panels may include exterior panels. The exterior panels may present a class-A surface, e.g., a finished surface exposed to view by a customer and free of unaesthetic blemishes and defects. The body panels include, e.g., a roof panels, doors, fenders, hood, decklid, etc. The vehicle body may define a passenger cabin to house occupants, if any, of the vehicle 24.

The vehicle frame 26 includes frame rails 30 and may include cross beams (not shown). The frame rails 30 are elongated along a vehicle-longitudinal axis L. The frame rails 30 are spaced from each other cross-vehicle. The cross beams of the vehicle frame 26 extend from one frame rail 30 to the other frame rail 30 transverse to the vehicle-longitudinal axis L.

The vehicle frame 26 includes two frame rails 30. The frame rails 30 may define the cross-vehicle boundaries of the vehicle frame 26. The frame rails 30 may be elongated along the vehicle-longitudinal axis L from a rear end of the vehicle 24 to a front end of the vehicle 24. For example, the frame rails 30 may extend along substantially the entire length of the vehicle 24. In other examples, the frame rails 30 may be segmented and extend under portions of the vehicle 24, e.g., at least extending from below a passenger compartment of the vehicle 24 to the front end of the vehicle 24. In some examples, each frame rail 30 may be unitary from the rear end of the vehicle 24 to the front end of the vehicle 24. In other examples, the frame rails 30 may include segments fixed to each other (e.g., by welding, threaded fastener, etc.) and in combination extending from a rear end of the vehicle 24 to the front end of the vehicle 24.

As set forth above, the vehicle frame 26 may have a body-on-frame construction in which the vehicle body is supported on and affixed to the vehicle frame 26. In such an example, the frame rails 30 may include cab mount brackets (not shown) on which the vehicle body is supported and affixed. The cab mount brackets are fixed to the frame rails 30, e.g., welded to the frame rails 30. The cab mount brackets may extend outboard from the frame rail 30. The cab mount bracket may be cantilevered from the frame rail 30. The cab mount brackets are configured to support the vehicle body in a body-on-frame configuration. For example, the cab mount bracket may include a post or a hole that receives a hole or a post, respectively, of the vehicle body to connect the vehicle body to the vehicle frame 26. Specifically, the vehicle body may be fixed to the cab mount bracket. During assembly of the vehicle 24, the vehicle body is set on the vehicle frame 26 with fastening features of the vehicle body aligned with the cab mount brackets for engagement with the cab mount brackets.

The vehicle frame 26 may include suspension and steering attachment points (not shown) that support suspension and steering components of the vehicle 24. As one example, the suspension and steering attachment points may be suspension towers. Suspension and steering components of the vehicle 24 are connected to the vehicle frame 26, at least in part, at the suspension towers. The suspension and steering components include suspension shocks, suspension struts, steering arms, steering knuckles, vehicle wheels, etc.

The vehicle frame 26 may have a powertrain compartment designed (not numbered) to support and house a vehicle powertrain between the frame rails 30. For example, at least one of the cross-beams of the vehicle frame 26 may be a powertrain cradle, i.e., a cross-beam designed to support and affix to the vehicle powertrain. The powertrain cradle may define a boundary of the powertrain compartment, e.g., a lower boundary of the powertrain compartment. The vehicle powertrain in the powertrain compartment may be, for example, an internal combustion engine and a transmission, in which case the powertrain cradle is an engine cradle. In other examples, the vehicle frame 26, e.g., the frame rails 30 and/or the cross beams, are designed to support battery assemblies. The battery assembly may be of any suitable type for vehicular electrification to power propulsion of the vehicle 24, for example, lithium-ion batteries, nickel-metal hydride batteries, lead-acid batteries, or ultracapacitors, as used in, for example, plug-in hybrid electric vehicles (PHEVs), hybrid electric vehicles (HEVs), or battery electric vehicles (BEVs).

The frame rails 30 and cross-beams may be extruded, roll-formed, etc. The frame rails 30 and cross-beams of the vehicle frame 26 may be of any suitable material, e.g., suitable types of steel, aluminum, and/or fiber-reinforced plastic, etc. The frame rails 30 and cross-beams may be hollow. The frame rails 30 and cross-beams may be rectangular in cross-section (e.g., a hollow rectangular cuboid), round in cross section, e.g., a hollow, round such as a hollow cylinder), etc.

The vehicle frame 26 includes the frame-rail ends 32 extending vehicle-forward of the frame rails 30, respectively. In other words, the vehicle frame 26 includes two frame-rail ends 32 with one frame-rail end 32 extending vehicle-forward of one of the frame rails 30 and the other frame-rail end 32 extending vehicle-forward of the other frame rail 30.

The frame-rail end 32 is fixed the respective frame rail 30. For example, the frame-rail end 32 may be fixed to the respective frame rail 30 by welding, fastening, etc. In the example shown in the Figures, the frame-rail end 32 is a component of the vehicle frame 26 that has a body-on-frame architecture, as described above. In other examples, the vehicle frame 26 may be of another architecture, e.g., a unibody architecture. In such examples, the frame rail 30 is a component of the vehicle frame 26 that has a unibody architecture and the frame-rail end 32 is connected to such frame rail 30.

The frame-rail end 32 is elongated along the vehicle-longitudinal axis L. For example, the frame-rail end 32 may be coaxial with the frame rail 30 at the connection of the frame-rail end 32 and the frame rail 30. The frame rail 30 has a vehicle-forward end and the frame-rail end 32 extends vehicle-forward from the vehicle-forward end of the frame rail 30. Specifically, the frame-rail end 32 has a vehicle-rearward end at the frame rail 30 and a vehicle-forward end, as described further below.

The frame-rail end 32 includes a base elongated along a vehicle-longitudinal axis L and a flange 34 extending radially from the base. The base may include the vehicle-rearward end of the frame-rail end 32. The flange 34 may be at the vehicle-forward end of the frame-rail end 32, as shown in the example shown in the Figures.

The flange 34 includes a vehicle-forward face. The vehicle-forward face faces in the vehicle-forward direction. The vehicle-forward face may be planar, as shown in the example in the Figures. As set forth below, the bracket 16 abuts the flange 34 at the vehicle-forward end of the frame-rail end 32. The vehicle-forward face of the flange 34 is at the vehicle-forward end of the frame-rail end 32 in the example shown in the Figures. In other examples, the vehicle-forward face of the flange 34 may be spaced vehicle-rearward of the vehicle-forward end of the frame-rail end 32.

The frame-rail end 32 includes mounting holes 36. Specifically, the mounting holes 36 may be in the flange 34 as shown in the example in the Figures. In such examples, the mounting holes 36 extend through the vehicle-forward face of the flange 34. The mounting holes 36 mount the bracket 16 to the frame-rail end 32, as described further below.

The frame-rail end 32 includes a bore 38 at the vehicle-forward end of the frame-rail end 32. The bore 38 extends through the vehicle-forward end of the frame-rail end 32. In other words, the bore 38 is open at the vehicle-forward end of the frame rail 30. The bore 38 may extend continuously through the frame-rail end 32 through both the vehicle-forward end and the vehicle-rearward end of the frame rail 30. The bore 38 is elongated along the vehicle-longitudinal axis L. The frame-rail end 32 may be extruded, roll-formed, etc. The frame-rail end 32 may be of any suitable material, e.g., suitable types of steel, aluminum, and/or fiber-reinforced plastic, etc. The frame-rail end 32 may be hollow, i.e., the bore 38 makes the frame-rail end 32 hollow. The frame rails 30 and cross-beams may be rectangular in cross-section (e.g., a hollow rectangular cuboid), round in cross section, e.g., a hollow, round such as a hollow cylinder), etc.

The frame-rail ends 32 are designed to deform relative to the frame rail 30 during frontal-vehicle impact. Specifically, the frame-rail ends 32 deform vehicle-rearward to allow rearward movement of the vehicle-bumper assembly 10 relative to the frame rails 30 to absorb energy during certain vehicle impacts. The frame-rail ends 32 may include features that direct deformation of the frame-rail end 32 toward the frame rail 30 during frontal impact of the bumper 12. These features may include wall geometry, wall thickness, dimples, cutouts, etc. The frame-rail ends 32 may be referred to in industry as crush cans.

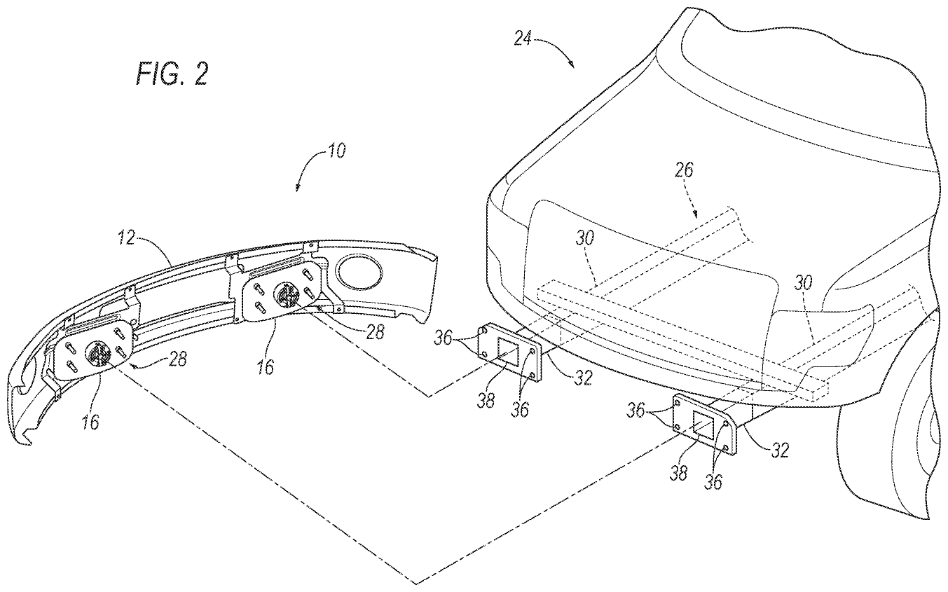

With reference to FIGS. 1-3, the vehicle 24 has a front-end structure. The front-end structure includes a grill and the bumper assembly. The grill is above the bumper assembly. The grill may be a component of the vehicle body and may be supported on other components of the vehicle body.

The vehicle-bumper assembly 10 includes the bumper 12 and the energy-absorber assembly 28. The bumper 12 and the energy absorber may be parts-in-assembly (PIA), i.e., assembled as a unit to the vehicle frame 26 at a vehicle assembly plant.

The vehicle-bumper assembly 10 is connected to the vehicle frame 26. Specifically, the bumper 12 is connected to the frame-rail ends 32 with the energy-absorber assembly 28, as described further below.

The bumper 12 extends transversely to the frame rails 30, e.g., in a cross-vehicle direction C. With reference to FIGS. 1-3, the bumper 12 is elongated along the cross-vehicle direction C. The bumper 12 is supported by the vehicle frame 26, i.e., the weight of the bumper 12 is borne by the vehicle frame 26. The vehicle-bumper assembly 10 may be a front bumper assembly, as shown in the Figures. In other words, the vehicle-bumper assembly 10 may be at a front of the vehicle 24 and, in such examples, the bumper 12 extension is operable for frontal collisions of the vehicle 24.

The vehicle-bumper assembly 10 is supported by the vehicle frame 26, i.e., the weight of the bumper assembly is borne by the vehicle frame 26. Specifically, the energy-absorber assembly 28 supports the bumper 12 on the vehicle frame 26. In other words, the weight of the bumper 12 is borne by the energy-absorber assembly 28 and the weight of the energy-absorber assembly 28 and the bumper 12 is borne by the vehicle frame 26 through the connection of the energy-absorber assembly 28 to the vehicle frame 26. The vehicle-bumper assembly 10 may be a front bumper assembly, as shown in the example in the Figures. In other words, the bumper assembly may be at a front of the vehicle 24 and, in such examples, the bumper retraction is operable for certain frontal collisions of the vehicle 24.

The bumper 12 extends transversely to the frame rails 30. With reference to FIG. 1, the bumper 12 is elongated along the vehicle-lateral axis C. The bumper 12 may be of any suitable material such as metal (steel, aluminum, etc.), fiber-reinforced plastic, etc.

The bumper 12 has a vehicle-forward face and a vehicle-rearward face. The vehicle-forward face may be a class-A surface, i.e., a surface specifically manufactured to have a high-quality, finished aesthetic appearance free of blemishes. As an example, the vehicle-forward face may be chromed. The bumper 12 may be of any suitable material such as metal (steel, aluminum, etc.), fiber-reinforced plastic, etc. The bumper 12 may have a mounting brace on the vehicle-rearward face of the bumper 12, as shown in the example in the Figures. The mounting brace is fixed to and moves as a unit with the rest of the bumper 12.

The bracket 16 is fixed relative to the vehicle frame 26. In other words, the bracket 16 moves as a unit with the vehicle frame 26. The bracket 16 may be fixed directly to the vehicle frame 26. The bracket 16 may be fixed to the vehicle frame 26 by mechanical attachment that requires removal by a service technician with the use of a tool and/or destruction such as cutting, e.g., cutting material and/or welded joints, etc. As an example, as shown in the Figures, the bracket 16 may be fixed directly to the frame-rail end 32. The bracket 16 may be fixed to the vehicle frame 26 in any suitable way such as fasteners, welding, etc. In the example shown in the Figures, the bracket 16 is fixed directly to the vehicle frame 26 with four threaded studs that extend through the holes in the flange of the frame-rail end 32 with threaded nuts retaining the flange to the bracket 16.

The bracket 16 is configured to be fixed relative to a vehicle frame 26. The bracket 16 is sized and shaped for connection to the vehicle frame 26. When fixed to the vehicle frame 26, the bracket 16 is spaced from the bumper 12 vehicle rearward from the bumper 12. The bracket 16 is spaced from the bumper 12 along the axis A of the rod 14. The axis A of the rod 14 may be, for example, parallel to the vehicle-longitudinal axis L.

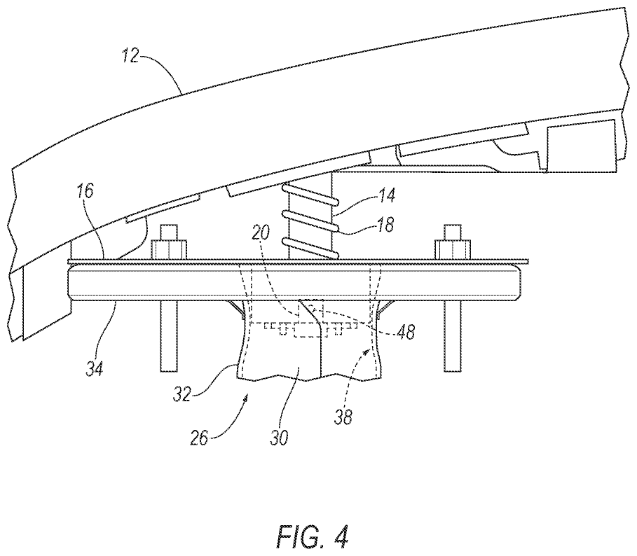

In the example shown in the Figures, the bracket 16 includes a base 40 and a standoff 42. The standoff 42 extends vehicle-rearward from the base 40 of the bracket 16. The standoff 42 may be, for example, cylindrical. The standoff 42 may be annular about the axis A of the rod 14, as shown in the example in the Figures. In other words, the standoff 42 may be coaxial with the rod 14. The standoff 42 may define a bore 44 that is coaxial with the rod 14. The rod 14 may extend into the bore 44 in the design position and the retracted position, as shown in the example in the Figures. The standoff 42 supports the keeper 20, as described further below. In the example shown in the Figures, the standoff 42, the keeper 20, and the lock 22 are in the bore 44 of the frame-rail end 32, as shown in FIG. 4.

The bumper 12 is movable with the rod 14 along the axis A of the rod 14 between the design position and the retracted position during certain vehicle impacts, as described herein. The bracket 16 movably receives the rod 14. For example, as shown in the example in the Figures, the bracket 16 may define a hole (not numbered) extending through the bracket 16, i.e., spaced from the outer periphery of the bracket 16 and the hole slidably receives the rod 14. A retainer 46 is fixed to the rod 14 along the axis A of the rod 14 to retain the rod 14 to the bracket 16 against the force of the spring 18. In the example shown in the Figures, the rod 14 is threaded and the retainer 46 is threaded, e.g., the retainer 46 is a threaded nut, is threadedly engaged with the rod 14 vehicle rearward of the bracket 16 to retain the rod 14 to the bracket 16. In such an example, the spring 18 forces the retainer 46 against the bracket 16. The rod 14 slides along the hole axially along the axis A of the rod 14 and the bumper 12 moves between the design position and the retracted position. The hole may be elongated along the axis A of the rod 14. In some examples, the hole may be elongated along the vehicle-longitudinal axis L. In other examples, the bracket 16 may include any suitable track, channel, etc., that slidably receives the rod 14.

The rod 14 is elongated along the axis A of the rod 14. In other words, the longest dimension of the rod 14 is along the axis A. The rod 14 may be, for example, cylindrical, as shown in the example in the Figures. The rod 14 may be, for example, metal or any other suitable material. The rod 14, or the rods 14 in examples including more than one rod 14, has sufficient rigidity to support the bumper 12 on the vehicle frame 26 and sufficient rigidity to transfer linear movement of the bumper 12 relative to the vehicle frame 26 during movement of the bumper 12 between the design position and the retracted position.

The rod 14 is fixed relative to the bumper 12 and selectively movable relative to the bracket 16. The rod 14 may be fixed to the bumper 12 by mechanical attachment that requires removal by a service technician with the use of a tool and/or destruction such as cutting, e.g., cutting material and/or welded joints, etc. In the example shown in the Figures, the rod 14 includes an end extending through the mounting bracket 16 of the bumper 12 that is threaded with opposing threaded fasteners on opposite sides of the mounting bracket 16.

The rod 14 is moveable axially relative to the bracket 16 when the lock 22 is in the unlocked position and force on the bumper 12 is sufficient to disengage the retainer from the bracket 16, e.g., slidable axially through the hole when force applied to the bumper 12 compresses the spring 18 and disengages the retainer from the bracket 16 when the lock 22 is in the disengaged position. The rod 14 is fixed axially relative to the bracket 16 when the lock 22 is in the locked position, i.e., the lock 22 locks the rod 14 to the bracket 16 relative to each other.

The spring 18 is between the bumper 12 and the bracket 16. Prior to assembly of the bumper assembly to the vehicle frame 26, the spring 18 is retained between the bumper 12 and the bracket 16. Specifically, as described above with respect to the example shown in the Figures, the rod 14 is fixed to the bumper 12 and the retainer 46 retains the rod 14 on the bracket 16 against the force of the spring 18. The spring 18 resiliently forces the bumper 12 away from the bracket 16 along the axis A of the rod 14 toward the extended position.

The spring 18 is operatively engaged with the bracket 16 and the bumper 12 to exert force the bumper 12 vehicle-forward away from the bracket 16 and vehicle frame 26 along the axis A. In the example shown in the Figures, the spring 18 abuts the bumper 12 and abuts the bracket 16. In some examples, the spring 18 is compressed between the bumper 12 and the bracket 16 in the design position. In other examples, the spring 18 may be relaxed in the design position with the spring 18 having a free length equal to the length of the rod 14 extending from the bracket 16 to the bumper 12 in the design position, e.g., when the retainer abuts the bracket 16. In both examples, the spring 18 maintains the bumper 12 in the design position and prevents vehicle-rearward movement of the bumper 12 relative to the vehicle frame 26 absent forces on the bumper 12 that exceed a force threshold for which the bumper 12 is designed to move toward the retracted position, e.g., during certain vehicle impacts. The force of the spring 18 between the bracket 16 and the bumper 12 is sufficient to prevent rattle of the bumper 12 and vehicle-rearward movement of the bumper 12 during driving of the vehicle 24 absent such forces. The spring 18 is resilient such that, in the event the spring 18 is compressed by vehicle-rearward force on the bumper 12, the spring 18 decompresses to force the bumper 12 vehicle-forward to the design position when the vehicle-rearward force on the bumper 12 is decreased or removed.

The spring 18, as an example, may be a coil spring. In the example shown in the Figures, the spring 18 is a coil spring 18 on the rod 14 between the bumper 12 and the vehicle frame 26, i.e., the coils of the coil spring 18 helically extend around the rod 14 along the axis A. In such an example, the spring 18 has an inner diameter sized to be received by the rod 14. The inner diameter of the spring 18 is larger than the outer diameter of the rod 14. The spring 18 may be metal.

The keeper 20 maintains the rod 14 in the extended position when the keeper 20 is engaged with the bracket 16. Specifically, the keeper 20 prevents vehicle-rearward movement of the rod 14 and the bumper 12 relative to the vehicle frame 26 when the keeper 20 is engaged with the bracket 16.

The keeper 20 is releasably engaged with the bracket 16. In other words, the keeper 20 remains engaged with the bracket 16 until a force exceeding a threshold force is applied to the keeper 20 to disengage the keeper 20 from the bracket 16. The keeper 20 remains engaged with the bracket 16 when force applied to the keeper 20 is below the threshold force.

The keeper 20 and the bracket 16 are designed so that the keeper 20 releases from the bracket 16 when force above the threshold force is applied to the keeper 20, specifically, when axial force on the rod 14 from the bumper 12 in the vehicle-rearward direction exceeds the threshold force. The threshold force has a non-zero magnitude. The threshold force may be the vehicle-rearward force on the bumper 12 experienced by the bumper 12 during certain vehicle impacts, e.g., during certain frontal-vehicle impacts with a pedestrian at a vehicle speed of 30 kph-50 kph (kilometers per hour). As an example, the threshold force may be 6 kN. The threshold force may be, for example, empirically determined.

A releasable connection is between the keeper 20 and bracket 16. The releasable connection is designed to release the keeper 20 from the bracket 16 when force above the threshold force is applied to the keeper 20, specifically, when axial force on the rod 14 from the bumper 12 in the vehicle-rearward direction exceeds the threshold force. For example, the releasable connection is designed to release the keeper 20 from the bracket 16 in response to certain frontal-vehicle impacts, as described above.

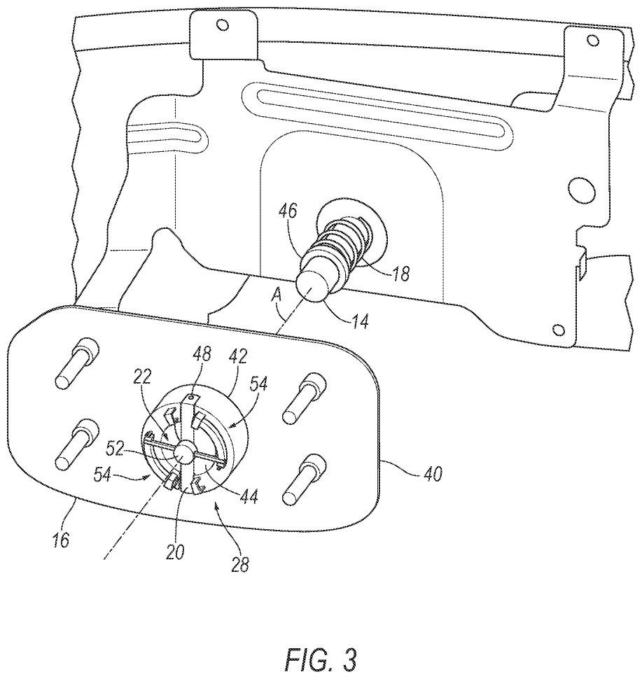

In some examples, including the example in FIGS. 3-5C, the releasable connection is a shear pin 48 between the keeper 20 and the bracket 16, e.g. the standoff 42 of the bracket 16. The shear pin 48 retains the keeper 20 to the bracket 16 in the absence of application of force above the threshold force on the rod 14 in the vehicle-rearward direction. In the event axial force on the rod 14 from the bumper 12 in the vehicle-rearward direction exceeds the threshold force, the shear pin 48 releases to release the keeper 20 from the bracket 16. In such examples, the shear pin 48 may undergo plastic shear deformation as the keeper 20 releases from the bracket 16. The shear pin 48 is designed to release the keeper 20 from the bracket 16 in response to application of axial force on the rod 14 from the bumper 12 in the vehicle-rearward direction exceeds the threshold force. Specifically, the shear pin 48 is sized, shaped, and positioned to release from the keeper 20 and/or the bracket 16, e.g., by plastic shear deformation of the shear pin 48, to release the keeper 20 from the bracket 16.

The shear pin 48 may be on one of the bracket 16 and the keeper 20 and a hole may be on the other of the bracket 16 and the keeper 20. The shear pin 48 is received in the hole (not numbered) and is retained in the hole in the absence of application of force above the threshold force. In the event axial force on the rod 14 from the bumper 12 in the vehicle-rearward direction exceeds the threshold force, the shear pin 48 releases from the hole. For example, the shear pin 48 and/or the hole deform to release the shear pin 48 from the hole. In some examples, the shear pin 48 and the hole are designed to release the shear pin 48 from the hole in response to application of axial force on the rod 14 from the bumper 12 in the vehicle-rearward direction exceeds the threshold force. Specifically, the shear pin 48 and hole are sized, shaped, and positioned to release the shear pin 48 from the hole to release the keeper 20 and/or the bracket 16, e.g., by plastic shear deformation of the shear pin 48, to release the keeper 20 from the bracket 16.

In the example shown in the Figures, the shear pin 48 is on the bracket 16, specifically the standoff 42 of the bracket 16, and in other examples the shear pin 48 may be on the keeper 20. In the example shown in the Figures, the two shear pins 48 are between the keeper 20 and the bracket 16. In other examples, any suitable number of shear pins 48, i.e., one or more, may be between the keeper 20 and the bracket 16.

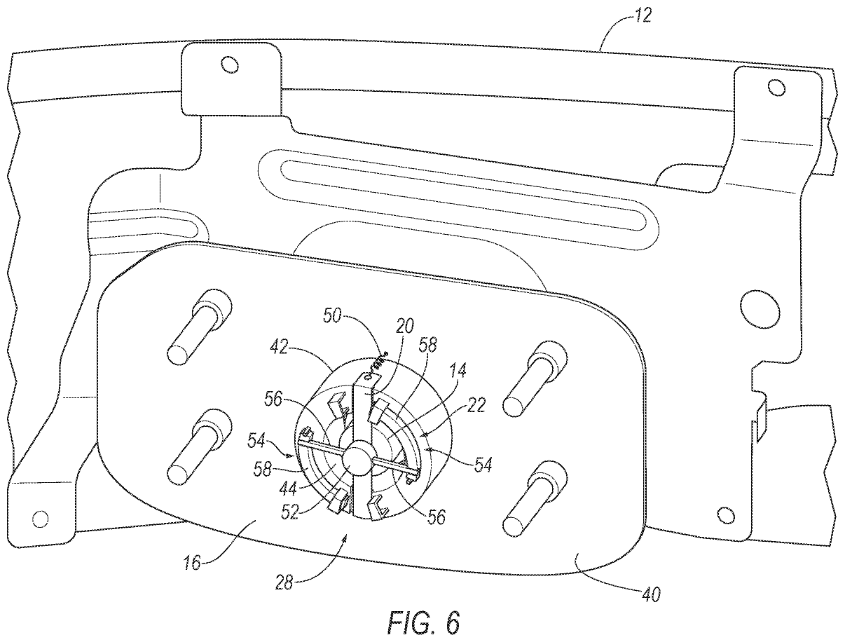

In another example, as shown in FIG. 6, the releasable connection is a keeper spring 50 between the keeper 20 and the bracket 16. The keeper spring 50 forces the keeper 20 against the standoff 42 in a vehicle-forward direction. The keeper spring 50 is designed (i.e., sized, shaped, positioned, and having a spring 18 constant) to act against forces on the bumper 12 that force the rod 14 to move axial vehicle-rearward against the force of the spring 18. The keeper spring 50 is designed to retain the keeper 20 to the bracket 16 in the absence of application of force above the threshold force on the rod 14 in the vehicle-rearward direction. In the event axial force on the rod 14 from the bumper 12 in the vehicle-rearward direction exceeds the threshold force, the keeper spring 50 is designed to release the keeper 20 from the bracket 16. In such examples, the keeper spring 50 undergoes elastic deformation as the keeper 20 releases from the bracket 16 and returns to its original position when the force is released. In other words, the energy-absorber assembly 28 is resettable. The keeper spring 50 may be, for example, a coil spring.

The bracket 16 may be between the keeper 20 and the bumper 12. In such an example, the rod 14 extends from the bumper 12 through the bracket 16 and to the keeper 20 in at least the retracted position. In the example shown in the Figures, the rod 14 extends from the bumper 12 through the bracket 16 and to the keeper 20 in both the design position and the retracted position. The rod 14 may abut the keeper 20 in the design position and the retracted position, as shown in the Figures.

The keeper 20 may be disposed on the axis A of the rod 14, as shown in the example in the Figures. The keeper 20 is disposed on the axis A of the rod 14 vehicle-rearward of the rod 14. Specifically, the keeper 20 may extend across the bore 38 with the axis A of the rod 14 projected from the rod 14 is transverse to the to the keeper 20. In the event of application of force to the bumper 12 that forces the rod 14 to move axially vehicle-rearward against the force of the spring 18, the rod 14 abuts the keeper 20 and applies a vehicle-rearward force to the keeper 20. In such an event, if the force on the bumper 12 exceeds the threshold force, the force of the rod 14 on the keeper 20 disengages the keeper 20 from the bracket 16, e.g., the standoff 42. In examples including the shear pins 48, the force of the rod 14 on the keeper 20 plastically deforms the shear pin 48 and/or the hole to release the keeper 20 from the bracket 16.

The lock 22 is movable between the locked position and the unlocked position. In the locked position, the lock 22 couples the keeper 20 and the bracket 16. Specifically, in the locked position, the lock 22 prevents disengagement of the keeper 20 from the bracket 16. In the unlocked position, the lock 22 is decoupled from the keeper 20 and/or the bracket 16 so that the lock 22 allows for disengagement of the keeper 20 from the bracket 16 in instances when the force on the bumper 12 exceeds the force threshold, as described above. The lock 22 is selectively movable between the locked position and the unlocked position. For example, the lock 22 may be movable between the locked position and the unlocked position based on vehicle speed. In some examples, the lock 22 may move to the locked position at vehicle speeds below 30 kph and above 50 kph and may move to the unlocked position at vehicle speeds between 30 kph and 50 kph.

The lock 22 is electronically operated based on commands from a vehicle 24 computer, as described further below, e.g., a body control module. The lock 22 may include an actuator 52 and a latch 54 movable by the actuator 52. The actuator 52 may be a motor, e.g., a DC motor. In the example shown in the Figures, the actuator 52 is a rotary motor that can rotate the actuator 52 in two directions.

The latch 54 is movable by the actuator 52 between the locked position and the unlocked position. In the locked position, the keeper 20 is between the latch 54 and the bracket 16 and the latch 54 prevents disengagement of the keeper 20 from the bracket 16. Specifically, the latch 54 prevents vehicle-rearward movement of the keeper 20 relative to the bracket 16. In the unlocked position, the latch 54 is disengaged with the keeper 20. When the latch 54 is disengaged with the keeper 20, the keeper 20 is able to disengage from the bracket 16 in instances when the force on the bumper 12 exceeds the force threshold, as described above. In the example shown in the Figures, in the locked position, the latch 54 is vehicle-rearward of the keeper 20, and in the unlocked position, the latch 54 is offset cross-vehicle from the keeper 20. In such examples, the latch 54 being vehicle-rearward of the keeper 20 in the locked position prevents vehicle-rearward movement of the keeper 20, and the latch 54 being offset cross-vehicle from the keeper 20 in the unlocked position allows for vehicle-rearward movement of the keeper 20 relative to the bracket 16. The latch 54 in the locked position may abut the keeper 20 or be close to the keeper 20 to a degree such that the keeper 20 cannot disengage from the bracket 16 in the event of force on the bumper 12 that exceeds the force threshold. The latch 54 provides clearance between the latch 54 and the keeper 20 to allow the keeper 20 to move vehicle rearward relative to the bracket 16 when the latch 54 is offset cross-vehicle from the keeper 20.

The latch 54 may include an arm 56 that extends from the actuator 52 and a bar 58 that extends from the arm 56. The actuator 52 moves the arm 56 and the bar 58 relative to the keeper 20 between the locked position and the unlocked position. The bar 58 may be, for example, transverse to the arm 56 at the intersection of the arm 56 and the bar 58. In other examples, the arm 56 and the bar 58 may curve into each other at the intersection of the arm 56 and the bar 58. The arm 56 and the bar 58 are fixed relative to each other and move together as a unit. In the example shown in the Figures, the arm 56 and the bar 58 are rotated together as a unit by the actuator 52. The arm 56 may be releasable from the bar 58, as described further below.

The lock 22 may include at least one catch 60 fixed to the bracket 16. The catch 60 is configured (i.e., sized, shaped, and positioned) to receive the latch 54 in the locked position to retain the latch 54 in the vehicle-rearward position relative to the bracket 16. In the locked position, the catch 60 anchors the bar 58 to the bracket 16 to prevent vehicle-rearward movement of the bar 58 relative to the bracket 16 and thus prevent vehicle-rearward movement of the keeper 20 relative to the bracket 16, e.g., in the event of force on the bumper 12 that exceeds the force threshold. In the unlocked position, the bar 58 does not anchor the keeper 20 to the bracket 16.

In the example shown in the Figures, two catches 60 are on the bracket 16 on opposite sides of the keeper 20. When the actuator 52 rotates the locked position, the bar 58 extends across the keeper 20 vehicle-rearward of the keeper 20 from one catch 60 to the other catch 60. In the example shown in the Figures, then the actuator 52 is in the unlocked position, the bar 58 does not extend vehicle-rearward of the keeper 20. As an example, in the example shown in the Figures, the bar 58 may remain engaged with one of the catches 60. In the example shown in the Figures, the arm 56 and the bar 58 rotate together about the axis A as a unit and the arm 56 may be releasable from the bar 58, as shown in FIG. 6C. Specifically, one of arm 56 and the bar 58 includes a channel designed to transmit rotational movement and the other of the arm 56 and the bar 58 may be in the channel and may be, in some examples, press fit, adhered, etc., in the channel. In such an example, the connection between the arm 56 and the bar 58 is designed to release in the event of force on the bumper 12 that exceeds the force threshold.

In the example shown in the Figures, the catch 60 is on the standoff 42 of the bracket 16. In examples in which the latch 54 includes the arm 56 and the bar 58, the catches 60 are configured to receive the bar 58 in the locked position. In the example shown in the Figures, the catches 60 have a hole that receive the bar 58.

In the example shown in the Figures, the actuator 52 is on the keeper 20. Specifically, the actuator 52 is supported on the keeper 20, i.e., the weight of the actuator 52 is borne by the keeper 20. The is fixed relative to the keeper 20 and moves as a unit with the keeper 20. In the event the keeper 20 moves relative to the bracket 16 when force on the bumper 12 exceeds the force threshold and the lock 22 is in the unlocked position, the actuator 52 and arms 56 move with the keeper 20 relative to the bracket 16. In some examples, wiring for the actuator 52 may extend across the keeper 20.

In the example shown in the Figures, the arm 56 extends radially from the actuator 52. The arm 56 is fixed to the actuator 52 and moves as a unit with the actuator 52. Rotation of the actuator 52, e.g., rotation of a shaft of the motor, rotates the arms 56 about the actuator 52 to extend the bar 58 across the catches 60. When the bar 58 extends across the catches 60, the connections of the bar 58 to the catches 60 anchor the keeper 20 to the bracket 16. In the example shown in the Figures, two catches 60 are on the bracket 16 and two latches 54 extend radially from the actuator 52 to engage the respective catch 60. Other examples include any suitable number of pairs of catches 60 and latches 54, i.e., one or more.

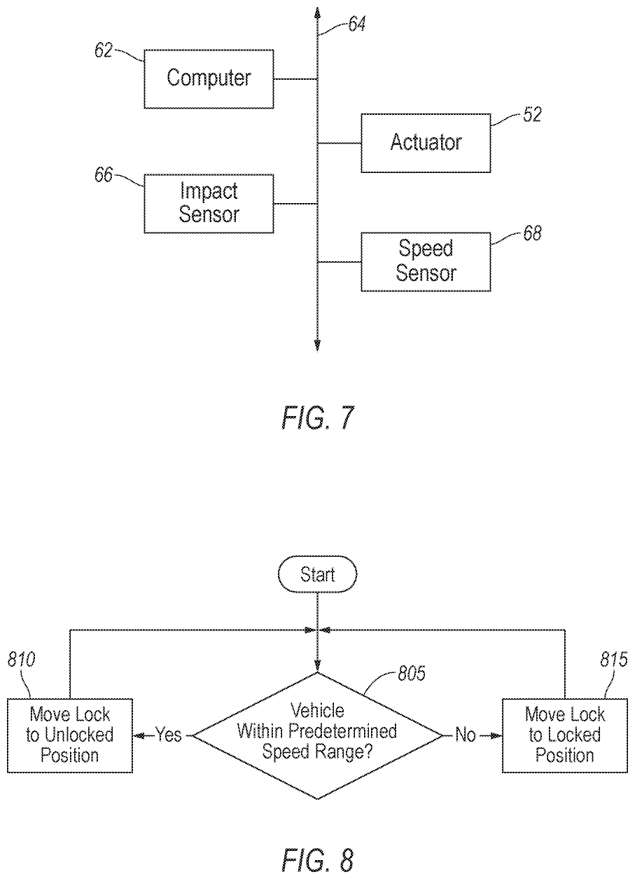

With reference to FIG. 7, the vehicle 24 includes the vehicle computer 62 a processor and a memory. The computer 62 may be a body control module. The memory includes one or more forms of computer readable media, and stores instructions executable by the computer for performing various operations, including as disclosed herein and including, for example, process shown in FIG. 8 and described below. For example, the computer 62 may be a generic computer with a processor and memory as described above and/or may include an electronic control unit ECU or controller for a specific function or set of functions, and/or a dedicated electronic circuit including an ASIC (application specific integrated circuit) that is manufactured for a particular operation, e.g., an ASIC for processing sensor data and/or communicating the sensor data. In another example, the computer 62 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the computer. The memory may be of any type, e.g., hard disk drives, solid state drives, servers, or any volatile or non-volatile media. The memory may store the collected data sent from the sensors. The memory may be a separate device from the computer 62, and the computer may retrieve information stored by the memory via a vehicle communication network 64, e.g., over a CAN bus, a wireless network, etc. Alternatively or additionally, the memory may be part of the computer, e.g., as a memory of the computer 62.

As shown in FIG. 7, the computer 62 is generally arranged for communications on the vehicle communication network 64 that may include a bus in the vehicle 24 such as a controller area network CAN or the like, and/or other wired and/or wireless mechanisms. Alternatively or additionally, in cases where the computer 62 includes a plurality of devices, the vehicle communication network 64 may be used for communications between devices represented as the computer 62 in this disclosure. Further, as mentioned below, various controllers and/or sensors may provide data to the computer 62 via the vehicle communication network 64.

With reference to FIG. 7, the vehicle 24 may include at least one impact sensor 66 for sensing certain vehicle impacts (e.g., impacts of a certain magnitude, direction, etc.) during and/or prior to impact. “Certain” indicates the type and/or magnitude of the impact. The type and/or magnitude of such “certain vehicle impacts” may be pre-stored in the computer, e.g., a restraints control module and/or a body control module. The impact sensor 66 may be of any suitable type, for example, post contact sensors such as accelerometers, pressure sensors, and contact switches; and pre-impact sensors 66 such as radar, LIDAR, and vision sensing systems. The vision sensing systems may include one or more cameras, CCD image sensors, CMOS image sensors, etc. The impact sensor 66 may be located at numerous points in or on the vehicle 24. The impact sensor 66 may be in communication with the computer 62.

With reference to FIG. 7, the vehicle 24 includes a speed sensor 68 that detects the speed the vehicle 24 is moving relative to ground. The speed sensor 68 may be of any suitable type, including, in some examples, those known in the art. The speed sensor 68 may be, for example, a wheel-speed sensors 68 that measuring the rotational speed of a vehicle wheel. In other examples, the speed sensor 68 may be of any suitable type. The speed sensor 68 is in communication with the vehicle computer 62, e.g., through the vehicle communication network 64.

With reference to FIG. 8, the computer 62 stores instructions to control components of the vehicle 24 according to the method 800 shown in FIG. 8. Use of “in response to,” “based on,” and “upon determining” herein, including with reference to FIG. 7, indicates a causal relationship, not merely a temporal relationship.

As shown in FIG. 8, the method includes moving the lock 22 to the unlocked position when the speed of the vehicle 24 is within a predetermined speed range and move the lock 22 to the locked position when the speed of the vehicle 24 is outside of the predetermined speed range. As an example, the predetermined speed range may have a lower boundary above zero. In such examples, the speed of the vehicle 24 may be outside of the predetermined speed range by being above or below the predetermined speed range. As one example, the predetermined speed range may be 30 kph-50 kph. The predetermined speed range is stored in the vehicle 24 computer, i.e., is predetermined.

With reference to block 805, the method includes determining whether the speed of the vehicle 24 is within the predetermined speed range. The vehicle 24 computer may determine whether the speed of the vehicle 24 is within the predetermined speed range based on data from the speed sensor 68 indicating the speed that the vehicle 24 is traveling.

With reference to block 810, if the speed of the vehicle 24 is outside of the predetermined speed range, the method 800 includes commanding the actuator 52 to move the lock 22 to the locked position. For example, in the example shown in the Figures, the actuator 52 rotates the arm 56 to engage the bar 58 with the catch 60. The actuator 52 is maintained in this position while the vehicle 24 travels at a speed outside of the predetermined speed range.

With reference to block 815, if the speed of the vehicle 24 is within the predetermined speed range, the method 800 includes moving the actuator 52 to the disengaged position. For example, in the example shown in the Figures, the actuator 52 rotates the arm 56 to disengage the bar 58 from the catch 60. The actuator 52 is maintained in this position while the vehicle 24 travels at a speed inside of the predetermined speed range.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle-bumper assembly comprising:
a bumper;
a rod fixed relative to the bumper and elongated along an axis;
a bracket spaced from the bumper along the axis of the rod, the rod being movably engaged with the bracket between a design position and a retracted position;
a spring between the bumper and the bracket, the spring resiliently forcing the bumper away from the bracket along the axis of the rod toward the design position;
a keeper releasably engaged with the bracket, the keeper maintaining the rod in the design position when the keeper is engaged with the bracket; and
a lock movable between a locked position in which the lock couples the keeper and the bracket and an unlocked position in which the lock is decoupled from the keeper and/or the bracket.

2. The vehicle-bumper assembly of claim 1, further comprising a releasable connection between the keeper and bracket.

3. The vehicle-bumper assembly as set forth in claim 2, wherein the releasable connection is designed to release the keeper from the bracket in response to certain frontal-vehicle impacts.

4. The vehicle-bumper assembly as set forth in claim 1, further comprising a shear pin between the keeper and the bracket.

5. The vehicle-bumper assembly as set forth in claim 1, wherein the rod extends through the bracket and the bracket is between the keeper and the bumper.

6. The vehicle-bumper assembly as set forth in claim 5, wherein the keeper is disposed on the axis of the rod.

7. The vehicle-bumper assembly as set forth in claim 6, wherein the lock includes an actuator and a latch movable by the actuator.

8. The vehicle-bumper assembly as set forth in claim 7, wherein the latch is movable by the actuator between the locked position in which the keeper is between the latch and the bracket and the unlocked position in which the latch is disengaged with the keeper.

9. The vehicle-bumper assembly as set forth in claim 7, wherein the actuator is on the keeper.

10. The vehicle-bumper assembly as set forth in claim 1, wherein the spring is on the rod.

11. A vehicle comprising:
a vehicle frame;
a bumper;
a rod fixed relative to the bumper and elongated along an axis;
a bracket fixed relative to the vehicle frame and spaced from the bumper along the axis of the rod, the rod being movably engaged with the bracket between a design position and a retracted position;
a spring between the bumper and the bracket, the spring resiliently forcing the bumper away from the bracket along the axis of the rod toward the design position;
a keeper releasably engaged with the bracket, the keeper maintaining the rod in the design position when the keeper is engaged with the bracket; and
a lock movable between a locked position in which the lock couples the keeper and the bracket and an unlocked position in which the lock decouples the keeper and/or the bracket.

12. The vehicle-bumper assembly of claim 11, further comprising a releasable connection between the keeper and bracket.

13. The vehicle-bumper assembly as set forth in claim 12, wherein the releasable connection is designed to release the keeper from the bracket in response to certain frontal-vehicle impacts.

14. The vehicle-bumper assembly as set forth in claim 11, further comprising a shear pin between the keeper and the bracket.

15. The vehicle-bumper assembly as set forth in claim 11, wherein the rod extends through the bracket and the keeper is on a vehicle-rearward side of the bracket.

16. The vehicle-bumper assembly as set forth in claim 15, wherein the keeper is disposed on the axis of the rod vehicle-rearward of the rod.

17. The vehicle-bumper assembly as set forth in claim 16, wherein the lock includes an actuator and a latch movable by the actuator.

18. The vehicle-bumper assembly as set forth in claim 17, wherein the latch is movable by the actuator between the locked position vehicle-rearward of the keeper and the unlocked position in which the latch is offset cross-vehicle from the keeper.

19. The vehicle-bumper assembly as set forth in claim 17, wherein the actuator is on the keeper.

20. The vehicle-bumper assembly as set forth in claim 11, wherein the spring is on the rod.
